(19) United States
(12) Patent Application Publication
(10) Pub. No.: US 2010/0274817 A1
(43) Pub. Date: Oct. 28, 2010

(54) METHOD AND APPARATUS FOR REPRESENTING SENSORY EFFECTS USING USER'S SENSORY EFFECT PREFERENCE METADATA

(76) Inventors: Bum-Suk CHOI, Daejeon (KR); Sanghyun JOO, Daejon (KR); Jong-Hyun JANG, Daejon (KR); Kwang-Roh PARK, Daejon (KR)

Correspondence Address: LADAS & PARRY LLP, 224 SOUTH MICHIGAN AVENUE, SUITE 1600, CHICAGO, IL, 60604, US

(21) Appl. No.: 12/761,556

(22) Filed: Apr. 16, 2010

Related U.S. Application Data
(60) Provisional application No. 61/169,720, filed on Apr. 16, 2009.

(51) Int. Cl. G06F 17/30

(52) U.S. Cl. 707/802; 707/E17.044

(57) ABSTRACT

Provided is a method and apparatus for representing sensory effect. The method includes: receiving preference information for predetermined sensory effect from a user; and generating user's sensory effects preference metadata including the preference information. The user's sensory effects preference metadata comprises light preference type information, flash preference type information, heating preference type information, cooling preference type information, wind preference type information, vibration preference type information, scent preference type information, fog preference type information, sprayer preference type information, and rigid body motion preference type information.

### CROSS-REFERENCE(S) TO RELATED APPLICATIONS

The present application claims priority of U.S. Provisional Patent Application No. 61/169,720 filed on Apr. 16, 2009, which are incorporated herein by reference in its entirety.

### BACKGROUND OF THE INVENTION

1. Field of the Invention

The present invention relates to a method and apparatus for representing sensory effects; and, more particularly, to a method and apparatus for representing sensory effects using user's sensory effect preference metadata.

2. Description of Related Art

In general, media includes audio and video. The audio may be voice or sound and the video may be a still image and a moving image. When a user consumes or reproduces media, a user uses metadata to obtain information about media. Here, the metadata is data about media. Meanwhile, a device for reproducing media has been advanced from devices reproducing media recorded in an analog format to devices reproducing media recorded in a digital format.

An audio output device such as speakers and a video output device such as a display device have been used to reproduce media.

FIG. 1 is a diagram for schematically describing a media technology according to the related art. As shown in FIG. 1, media is outputted to a user using a media reproducing device 104. The media reproducing device 104 according to the related art include only devices for outputting audio and video. Such a conventional service is referred as a single media single device (SMSD) based service in which one media is reproduced through one device.

Meanwhile, audio and video technologies have been advanced to effectively provide media to a user. For example, an audio technology has been developed to process an audio signal to a multi-channel signal or a multi-object signal or a display technology also has been advanced to process video to a high quality video, a stereoscopic video, and a three dimensional image.

Related to a media technology, a moving picture experts group (MPEG) has introduced MPEG-1, MPEG-2, MPEG-4, MPEG-7, and MPEG-21 and has developed new media concept and multimedia processing technology. MPEG-1 defines a formation for storing audio and video and MPEG-2 defines specification about audio transmission. MPEG-4 defines an object-based media structure. MPEG-7 defines specification about metadata related to media, and MPEG-21 defines media distribution framework technology.

Although realistic experiences can be provided to a user through 3-D audio/video devices due to the development of the media technology, it is very difficult to realize sensory effects only with audio/video devices and media.

### SUMMARY OF THE INVENTION

An embodiment, of the present invention is directed to providing a method and apparatus for representing sensory effects in order to maximize media reproducing effects by realizing sensory effects when media is reproduced.

In accordance with an aspect of the present invention, there is provided a method for providing sensory device capability information, comprising: obtaining capability information for sensory devices; and generating sensory device capability metadata including the capability information, wherein the sensory device capability metadata includes light capability type information, flash capability type information, heating capability type information, cooling capability type information, wind capability type information, vibration capability type information, scent capability type information, fog capability type information, sprayer capability type information, and rigid body motion capability type information.

In accordance with another aspect of the present invention, there is provided an apparatus for providing sensory device capability information, comprising: a controlling unit configured to obtain capability information about sensory devices and to generate sensory device capability metadata including the capability information, wherein the sensory device capability metadata includes light capability type information, flash capability type information, heating capability type information, cooling capability type information, wind capability type information, vibration capability type information, scent capability type information, fog capability type information, sprayer capability type information, and rigid body motion capability type information.

In accordance with another aspect of the present invention, there is provided a method for representing sensory effects, comprising: receiving sensory effect metadata including sensory effect information about sensory effects applied to media; obtaining the sensory effect information by analyzing the sensory effect metadata; receiving sensory device capability metadata including capability information about sensory devices; and generating sensory device command metadata for controlling sensory devices corresponding to the sensory effect information by referring to the capability information included in the sensory device capability metadata, wherein the sensory device capability metadata includes light capability type information, flash capability type information, heating capability type information, cooling capability type information, wind capability type information, vibration capability type information, scent capability type information, fog capability type information, sprayer capability type information, and rigid body motion capability type information.

In accordance with another aspect of the present invention, there is provided an apparatus for representing sensory effects, comprising: an input unit configured to receive sensory effect metadata having sensory effect information about sensory effects applied to media and sensory device capability metadata having capability information of sensory devices; a controlling unit configured to obtain the sensory effect information by analyzing the sensory effect metadata and to control sensory devices corresponding to the sensory effect information by referring to the capability information, wherein the sensory device capability metadata includes light capability type information, flash capability type information, heating capability type information, cooling capability type information, wind capability type information, vibration capability type information, scent capability type information, fog capability type information, sprayer capability type information, and rigid body motion capability type information.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### BRIEF DESCRIPTION OF THE DRAWINGS

FIG. 1 is a schematic diagram illustrating a media technology according to the related art.

FIG. 2 is a conceptual diagram illustrating realizing sensor effect media in accordance with an embodiment of the present invention.

FIG. 3 is a diagram illustrating a single media multiple device (SMMD) system for representing sensory effects in accordance with an embodiment of the present invention.

FIG. 4 is a diagram illustrating a sensory media generator in accordance with an embodiment of the present invention.

FIG. 5 is a block diagram illustrating an apparatus for representing sensory effects in accordance with an embodiment of the present invention.

FIG. 6 is block diagram illustrating an apparatus for providing sensory device capability information in accordance with an embodiment of the present invention.

FIG. 7 is a block diagram illustrating an apparatus for providing user's sensory effect preference information in accordance with an embodiment of the present invention.

FIG. 8 is a diagram illustrating relationship between adaptation engine and metadata.

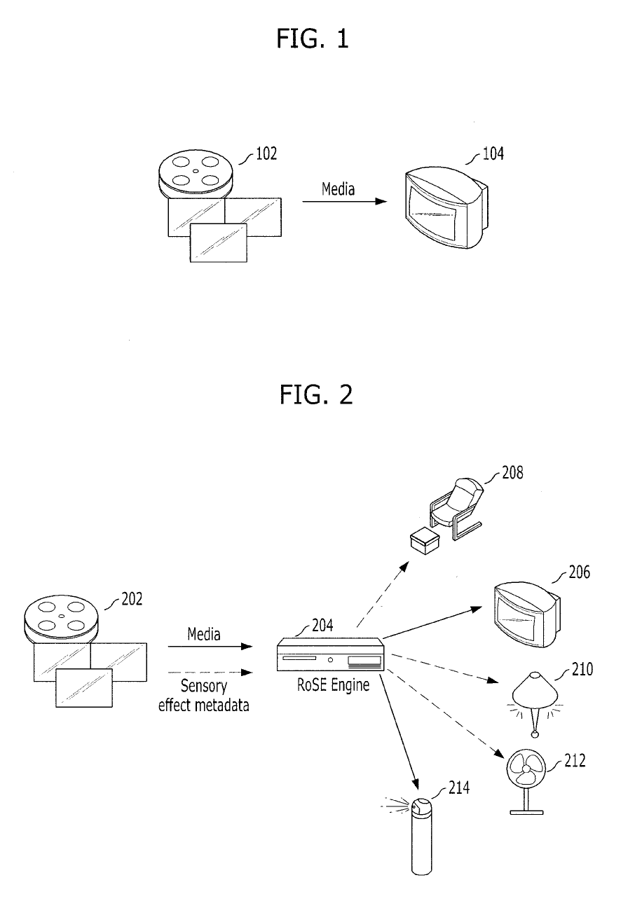

### DESCRIPTION OF SPECIFIC EMBODIMENTS

The advantages, features and aspects of the invention will become apparent from the following description of the embodiments with reference to the accompanying drawings, which is set forth Hereafter. In addition, if further detailed description on the related prior arts is determined to obscure the point of the present invention, the description is omitted. Hereafter, preferred embodiments of the present invention will be described in detail with reference to the drawings. The same reference numeral is given to the same element, although the element appears in different drawings.

Conventionally, audio and video are only objects of media generation and consumption such as reproducing. However, human has not only visual and auditory senses but also olfactory and tactile senses. Lately, many studies have been made to develop a device stimulating all of the five senses of human.

Meanwhile, home appliances controlled by an analog signal have been advanced to home appliances controlled by a digital signal.

Media has been limited as audio and video only. The concept of media limited as audio and video may be expanded by controlling devices that stimulate other senses such as olfactory or tactile sense with media incorporated. That is, a media service has been a single media single device (SMSD) based service in which one media is reproduced by one device. However, in order to maximize media reproducing effect in ubiquitous home, a single media multi device (SMMD) based service may be realized. The SMMD based service reproduces one media through multiple devices.

Therefore, it is necessary to advance a media technology for reproducing media to simply watch and listen to a sensory effect type media technology for representing sensory effects with media reproduced in order to satisfy five senses of human. Such a sensory effect type media may extend a media industry and a market of sensory effect devices and provide rich experience to a user by maximizing media reproducing effect. Therefore, a sensory effect type media may promote the consumption of media.

FIG. 2 is a diagram illustrating realization of sensory effect media in accordance with an embodiment of the present invention.

Referring to FIG. 2, media 202 and sensory effect metadata are input to an apparatus for representing sensory effects. Here, the apparatus for representing sensory effects is also referred as a representation of sensory effect engine (RoSE Engine) 204. Here, the media 202 and the sensory effect metadata may be input to the representation of sensory effect engine (RoSE Engine) 204 by independent providers. For example, a media provider (not shown) may provide media 202 and a sensory effect provider (not shown) may provide the sensory effects metadata.

The media 202 includes audio and video, and the sensory effect metadata includes sensory effect information for representing or realizing sensory effects of media 202. The sensory effect metadata may include all information for maximizing reproducing effects of media 202. FIG. 2 exemplarily shows visual sense, olfactory sense, and tactile sense as sensory effects. Therefore, sensory effect information includes visual sense effect information, olfactory sense effect information, and tactile sense effect information.

The RoSE engine 204 receives media 202 and controls a media output device 206 to reproduce the media 202. The RoSE engine 204 controls sensory effect devices 208, 210, 212, and 214 using visual effect information, olfactory effect information, and tactile effect information included in sensory effect metadata. Particularly, the RoSE engine 204 controls lights 210 using the visual effect information, controls a scent device 214 using the olfactory effect information, and controls a trembling chair 208 and a fan 212 using the tactile effect information.

For example, when video including a scene of lightning or thunder is reproduced, lights 210 are controlled to be turned on and off. When video including a scene of foods or a field is reproduced, the scent device 214 is controlled. Further, when video including a scene of water rafting or car chasing is reproduced, the trembling chair 208 and the fan 212 are controlled. Accordingly, sensory effects can be realized corresponding to scenes of video while reproducing.

In order to realize sensory effects, it is necessary to define a schema to express sensory effect information such as intensity of wind, color of light, and intensity of vibration in a standard format. Such a standardized schema for sensory effect information is referred as sensory effect metadata (SEM). When the sensory effect metadata is input to the RoSE engine 204 with the media 202, the RoSE engine 204 analyzes the sensory effect metadata that is described to realize sensory effects at predetermined times while reproducing the media 202. Further, the RoSE engine 204 controls sensory effect devices with being synchronized with the media 202.

The RoSE engine 204 needs to have information about various sensory devices in advance for representing sensory effects. Therefore, it is necessary to define metadata for expressing information about sensory effect devices. Such metadata is referred to as a sensory device capability metadata (SDCap). The sensory device capability metadata includes information about positions, directions, and capabilities of sensory devices.

A user who wants to reproduce media 202 may have various preferences for specific sensory effects. Such a preference may influence representation of sensory effects. For example, a user may not like a red color light. Or, when a user wants to reproduce media 202 in the middle of night, the user may want a dim lighting and a low sound volume. By expressing such preferences of a user about predetermined sensory effects as metadata, various sensory effects may be provided to a user. Such metadata is referred to as user's sensory effect preference metadata (USP).

Before representing sensory effects, the RoSE engine 204 receives sensory effect capability metadata from each of sensory effect devices and user's sensory effect preference metadata through an input device or from sensory effect devices. The RoSE engine 204 controls sensory effect devices with reference to the sensory effect capability metadata and the user's sensory effect preference metadata USP. Such a control command is transferred to each of the sensory devices in a form of metadata. The metadata is referred to as a sensory device command metadata (SDCmd).

Hereafter, a method and apparatus for representing sensory effects in accordance with an embodiment of the present invention will be described in detail.

<Definitions of Terms>

1. Provider

The provider is an object that provides sensory effect metadata. The provider may also provide media related to the sensory effect metadata.

For example, the provider may be a broadcasting service provider.

2. Representation of Sensory Effect (RoSE) Engine

The RoSE engine is an object that receives sensory effect metadata, sensory device capabilities metadata, and user's sensory effect preference metadata, and generates sensory device commands metadata based on the received metadata.

3. Consumer Devices

The consumer device is an object that receives sensory device command metadata and provides sensory device capabilities metadata. Also, the consumer device may be an object that provides user's sensory effect preference metadata. The sensory devices are a sub-set of the consumer devices.

For example, the consumer device may be fans, lights, scent devices, and human input devices such as a television set with a remote controller.

4. Sensory Effects

The sensory effects are effects that augment perception by stimulating senses of human at a predetermined scene of multimedia application.

For example, the sensory effects may be smell, wind, and light.

5. Sensory Effect Metadata (SEM)

The sensory effect metadata (SEM) describes effect to augment perception by stimulating human senses in a particular scene of a multimedia application

6. Sensory Effect Delivery Format

The sensory effect delivery format defines means for transmitting the sensory effect metadata (SEM).

For example, the sensory effect delivery format may include a MPEG2-TS payload format, a file format, and a RTP payload format.

7. Sensory Devices

The sensory devices are consumer device or actuator by which the corresponding Sensory Effect can be produced.

For example, the sensory devices may include light, fans, and heater.

8. Sensory Device Capability

The sensory device capability defines description to represent the characteristics of Sensory Devices in terms of the capability of the given sensory device.

9. Sensory Device Capability Delivery Format

The sensory device capability delivery format defines means for transmitting sensory device capability.

For example, the sensory device capability delivery format may include hypertext transfer protocol (HTTP), and universal plug and play (UPnP).

10. Sensory Device Command

The sensory device command defines description schemes and descriptors for controlling sensory devices.

For example, the sensory device command may include an XML schema.

11. Sensory Device Command Delivery Format

The sensory device command delivery format defines means for transmitting the sensory device command.

For example, the sensory device command delivery format may include HTTP and UPnP.

12. User's Sensory Effect Preference

The user's sensory effect preference defines description to represent user's preferences with respect to rendering of Sensory Effects.

13. User's Sensory Effect Preference Delivery Format

The user's sensory effect preference delivery format defines means for transmitting user's sensory effect preference.

For example, the user's sensory effect preference delivery format may include HTTP or UPnP.

14. Adaptation Engine

Adaptation engine is an entity that takes the Sensory Effect Metadata, the Sensory Device Capabilities, the Sensor Capabilities, and/or the User's Sensory Effect Preferences as inputs and generates Sensory Device Commands and/or the Sensed Information based on those.

For example, the adaptation engine may include RoSE engine.

15. Control Information Description Language (CIDL)

CIDL is a description tool to provide basic structure in XML schema for instantiations of control information tools including sensory device capabilities, sensor capabilities and user's sensory effect preferences.

16. Sensor

Sensor is a consumer device by which user input or environmental information can be gathered.

For example, the sensor may include temperature sensor, distance sensor, or motion sensor.

17. Sensor Capability

Sensor capability is a description to represent the characteristics of sensors in terms of the capability of the given sensor such as accuracy, or sensing range.

For example, the sensor capability may include lights, fans, or heater.

<System for Representing Sensory Effects>

Hereafter, an overall structure and operation of a system for representing sensory effects in accordance with an embodiment of the present invention will be described in detail.

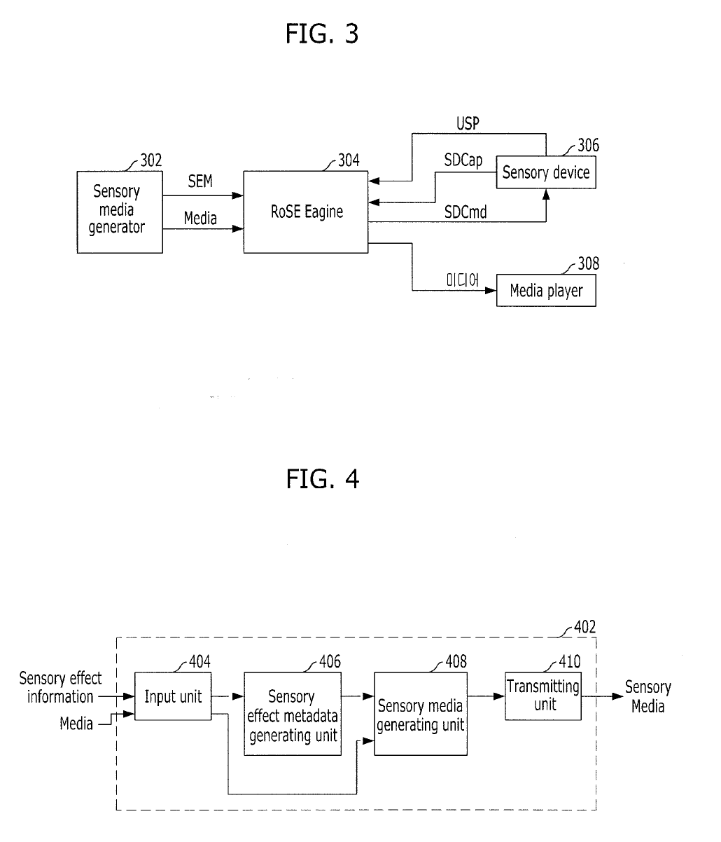

FIG. 3 is a diagram illustrating a single media multiple device (SMMD) system for representing sensory effects in accordance with an embodiment of the present invention.

Referring to FIG. 3, the SMMD system in accordance with the embodiment of the present embodiment includes a sensory media generator 302, a representation of sensory effects (RoSE) engine 304, a sensory device 306, and a media player 308.

The sensory media generator 302 receives sensory effect information about sensory effects applied to media and generates sensory effect metadata (SEM) including the received sensory effect information. Then, the sensory media generator 302 transmits the generated sensory effect metadata to the RoSE engine 304. Here, the sensory media generator 302 may transmit media with the sensory effect metadata.

Although it is not shown in FIG. 3, a sensory media generator 302 according to another embodiment may transmit only sensory effect metadata. Media may be transmitted to the RoSE engine 304 or the media player 308 through additional devices. The sensory media generator 302 generates sensory media by packaging the generated sensory effect metadata with the media and may transmit the generated sensory media to the RoSE engine 304.

The RoSE engine 304 receives sensory effect metadata including sensory effect information about sensory effects applied to media and obtains sensory effect information by analyzing the received sensory effect metadata. The RoSE engine 304 controls the sensory device 306 of a user in order to represent sensory effects while reproducing media using the obtained sensory effect information. In order to control the sensory devices 306, the RoSE engine 304 generates the sensory device command metadata (SDCmd) and transmits the generated sensory device command metadata to the sensory device 306. In FIG. 3, one sensory device 306 is shown for convenience. However, a user may possess a plurality of sensory devices.

In order to generate the sensory device command metadata, the RoSE engine 304 needs information about capabilities of each sensory device 306. Therefore, before generating the sensory device command metadata, the RoSE engine 304 receives sensory device capability metadata (SDCap) that includes the information about capabilities of sensory devices 306. The RoSE engine 304 obtains information about states and capabilities of each sensory device 306 from the sensory device capability metadata. The RoSE engine 304 generates sensory device command metadata for realizing sensory effects that can be realized by each of sensory devices using the obtained information. Here, the controlling the sensory devices include synchronizing the sensory devices with scenes that are reproduced by the media player 308.

In order to control the sensory device 306, the RoSE engine 304 and the sensory device 306 may be connected through networks. Particularly, LonWorks or Universal Plug and Play technologies may be applied as the network technology. In order to effectively provide media, media technologies such as MPEG including MPEG-7 and MPEG-21 may be applied together.

A user having the sensory device 306 and the media player 308 may have various preferences about predetermined sensory effects. For example, the user may dislike a predetermined color or may want strong vibration. Such user's sensory effect preference information may be input through the sensory device 306 or an additional input terminal (not shown). Further, the user's sensory effect preference information may be generated in a form of metadata. Such metadata is referred to as user's sensory effect preference metadata USP. The generated user's sensory effect preference metadata is transmitted to the RoSE engine 304 through the sensory device 306 or the input terminal (not shown). The RoSE engine 304 may generate sensory device command metadata in consideration of the received user's sensory effect preference metadata.

The sensory device 306 is a device for realizing sensory effects applied to media. Particularly, the sensory device 306 includes exemplary devices as follows. However, the present invention is not limited thereto.
visual device: monitor, TV, wall screen
sound device: speaker, music instrument, and bell
wind device: fan, and wind injector
temperature device: heater and cooler
lighting device: light, dimmer, color LED, and flash
shading device: curtain, roll screen, and door
vibration device: trembling chair, joy stick, and tickler
scent device: perfumer
diffusion device: sprayer
rigid body motion device: motion chair
other device: devices that produce undefined effects and combination of the above devices

A user may have more than one of sensory devices 306. The sensory devices 306 receive the sensory device command metadata from the RoSE engine 304 and realize sensory effects defined in each scene by synchronizing it with the media.

The media player 308 is a device for reproducing media, such as TV. Since the media player 308 is a kind of device for representing video and audio, the media reproduce 308 may be included in the sensory device 306. In FIG. 3, however, the media player 308 is independently shown for convenience. The media player 308 receives media from the RoSE engine 304 or through additional path and reproduces the received media.

<Method and Apparatus for Generating Sensory Media>

Hereafter, a method and apparatus for generating sensory media in accordance with an embodiment of the present invention will be described in detail.

The method for generating sensory media in accordance with the embodiment of the present embodiment includes receiving sensory effect information about sensory effects applied to media; and generating sensory effect metadata including the sensory effect information. The sensory effect metadata includes sensory effect description information. The sensory effect description information includes media location information. The media location information describes about locations in media where sensory effects are applied to.

The method for generating sensory media in accordance with the embodiment of the present embodiment further includes transmitting the generated sensory effect metadata to a RoSE engine. The sensory effect metadata may be transmitted as independent data separated from media. For example, when a user requests a movie service, a provider may transmit sensory effect metadata with media data (movie). If a user already has a predetermined media data (movie), a provider may transmit only corresponding sensory effect data applied to the media data.

The method for generating sensory media according to the present invention further includes generating sensory media by packaging the generated sensory effect metadata with media and transmitting the generated sensory media. A provider may generate sensory effect metadata for media, generate sensory media by combining or packaging the generated sensory effect metadata with media, and transmit the generated sensory media to the RoSE engine. The sensory media may be formed of files in a sensory media format for representing sensory effects. The sensory media format may be a file format to be defined as a standard for representing sensory effects.

In the method for generating sensory media in accordance with the embodiment of the present embodiment, the sensory effect metadata includes sensory effect description information that describes sensory effects. The sensory effect metadata further includes general information about generation of metadata. The sensory effect description information includes media location information that shows locations in media where the sensory effects are applied to. The sensory effect description information further includes sensory effect segment information about segments of media. The sensory effect segment information may include effect list information about sensory effects to be applied to segments in media, effect variable information, and segment location information representing locations where sensory effects are applied to. The effect variable information may include sensory effect fragment information containing at least one of sensory effect variables that are applied at the same time.

FIG. 4 is a diagram illustrating a sensory media generator in accordance with an embodiment of the present invention.

Referring to FIG. 4, the sensory media generator 402 includes an input unit 404 for receiving sensory effect information about sensory effects applied to media, and a sensory effect metadata generating unit 406 for generating sensory effect metadata including sensory effect information. The sensory effect metadata includes sensory effect description information that describes sensory effects. The sensory effect description information includes media location information that represents locations in media where sensory effects are applied to. The sensory media generator 402 further includes a transmitting unit 410 for transmitting sensory effect metadata to a RoSE engine. Here, the media may be input through the input unit 404 and transmitted to the RoSE engine or a media player through the transmitting unit 410. Alternatively, the media may be transmitted to the RoSE engine or the media player through an additional path without passing through the input unit 404.

Meanwhile, the sensory media generator 402 may further include a sensory media generating unit 408 for generating sensory media by packaging the generated sensory effect metadata with media. The transmitting unit 410 may transmit the sensory media to the RoSE engine. When the sensory media is generated, the input unit 404 receives the media. The sensory media generating unit 408 generates sensory media by combining or packaging the input media from the input unit 404 with the sensory effect metadata generated from the sensory effect metadata generating unit 406.

The sensory effect metadata includes sensory effect description information that describes sensory effects. The sensory effect metadata may further include general information having information about generation of metadata. The sensory effect description information may include media location information that shows locations in media where sensory effects are applied to. The sensory effect description information may further include sensory effect segment information about segments of media. The sensory effect segment information may include effect list information about sensory effects applied to segments of media, effect variable information, and segment location information that shows locations in segments where sensory effects are applied to. The effect variable information includes sensory effect fragment information. The sensory effect fragment information includes at least one of sensory effect variables that are applied at the same time.

<Method and Apparatus for Representing Sensory Effects>

Hereafter, a method and apparatus for representing sensory effects in accordance with an embodiment of the present invention will be described in detail.

The method for representing sensory effects in accordance with the embodiment of the present embodiment includes receiving sensory effect metadata including sensory effect information about sensory effects applied to media, obtaining the sensory effect information by analyzing sensory effect metadata; and generating sensory device command metadata to control sensory devices corresponding to the sensory effect information. The method for representing sensory effects in accordance with the embodiment of the present embodiment further includes transmitting the generated sensory effect command metadata to sensory devices. The sensory device command metadata includes sensory device command description information for controlling sensory devices.

The method for representing sensory effects in accordance with the embodiment of the present embodiment further includes receiving sensory device capability metadata. The receiving sensory device capability metadata may further include referring to capability information included in the sensory device capability metadata.

The method for representing sensory effects in accordance with the embodiment of the present embodiment may further include receiving user's sensory effect preference metadata having preference information about predetermined sensory effects. The generating sensory device command metadata may further include referring to the preference information included in user's sensory effect preference metadata.

In the method for representing sensory effects in accordance with the embodiment of the present embodiment, the sensory device command description information included in the sensory device command metadata may include device command general information that includes information about whether a switch of a sensory device is turned on or off, about a location to setup, and about a direction to setup. Further, the sensory device command description information may include device command detail information. The device command detail information includes detailed operation commands for sensory devices.

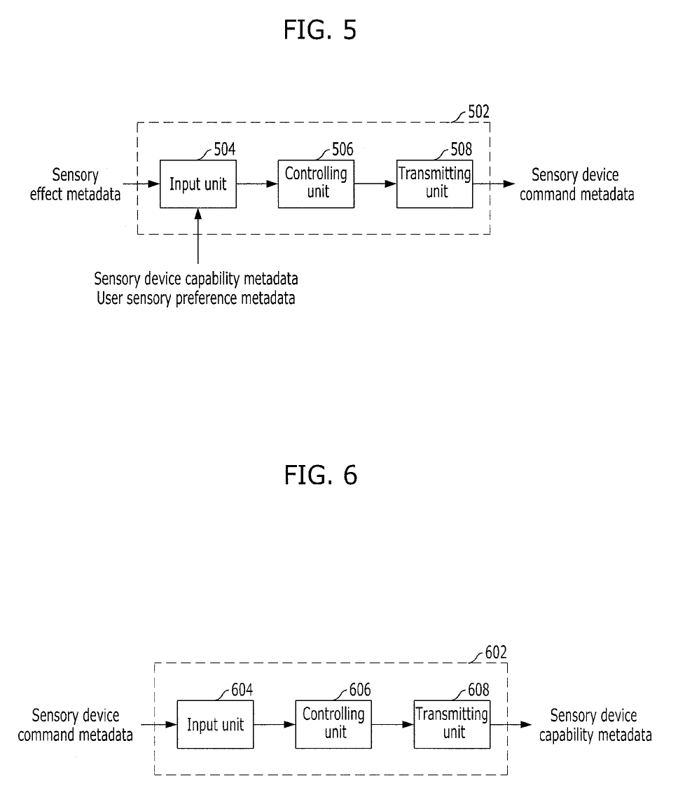

FIG. 5 is a block diagram illustrating an apparatus for representing sensory effects, which is referred to as a representation of sensory effects (RoSE) engine, in accordance with an embodiment of the present invention.

Referring to FIG. 5, the RoSE engine 502 in accordance with the embodiment of the present embodiment includes an input unit 504 for receiving sensory effect metadata having sensory effect information about sensory effects applied to media, and a controlling unit 506 for obtaining sensory effect information by analyzing the received sensory effect metadata and generating sensory effect command metadata to control sensory devices corresponding to the sensory effect information. The sensory device command metadata includes sensory device command description information to control sensory devices. The RoSE engine 502 may further include a transmitting unit 508 for transmitting the generated sensory device command metadata to sensory devices.

The input unit 504 may receive sensory device capability metadata that include capability information about capabilities of sensory devices. The controlling unit 506 may refer to the capability information included in the sensory device capability metadata to generate sensory device command metadata.

The input unit 504 may receive user's sensory effect preference metadata that includes preference information about preferences of predetermined sensory effects. The controlling unit 506 may refer to the preference information included in the user's sensory effect preference metadata to generate the sensory device command metadata.

The sensory device command description information included in the sensory device command metadata may include device command general information that includes information about whether a switch of a sensory device is turned on or off, about a location to setup, and about a direction to setup. The sensory device command description information may include device control detail information including detailed operation commands for each sensory device.

<Method and Apparatus for Providing Sensory Device Capability Information>

Hereafter, a method and apparatus for providing sensory device capability information in accordance with an embodiment of the present invention will be described in detail.

The method for providing sensory device capability information in accordance with the embodiment of the present embodiment includes obtaining capability information about sensory devices; and generating sensory device capability metadata including the capability information. The sensory device capability metadata includes device capability information that describes capability information. The method for providing sensory device capability information in accordance with the embodiment of the present embodiment may further include transmitting the generated sensory device capability metadata to a RoSE engine.

Meanwhile, the method for providing sensory device capability information in accordance with the embodiment of the present embodiment may further include receiving sensory device command metadata from the RoSE engine and realizing sensory effects using the sensory device command metadata. The RoSE engine generates the sensory effect device command metadata by referring to the sensory device capability metadata.

In the method for providing sensory device capability information in accordance with the embodiment of the present embodiment, the device capability information included in the sensory device capability metadata may include device capability common information that include information about locations and directions of sensory devices. The device capability information includes device capability detail information that includes information about detailed capabilities of sensory devices.

FIG. 6 is block diagram illustrating an apparatus for providing sensory device capability information in accordance with an embodiment of the present invention.

The apparatus 602 for providing sensory device capability information may be a device having the same function of a sensory device or may be a sensory device itself. The apparatus 602 may be a stand-alone device independent from a sensory device.

As shown in FIG. 6, the apparatus 602 for providing sensory device capability information includes a controlling unit 606 for obtaining capability information about capabilities of sensory devices and generating the sensory device capability metadata including capability information. Here, the sensory device capability metadata includes device capability information that describes capability information. The apparatus 602 for providing sensory device capability information in accordance with the embodiment of the present embodiment further include a transmitting unit 608 for transmitting the generated sensory device capability metadata to the RoSE engine.

The apparatus 602 for providing sensory device capability information may further include an input unit 604 for receiving sensory device command metadata from the RoSE engine. The RoSE engine refers to the sensory device capability metadata to generate the sensory device command metadata. Here, the controlling unit 606 realizes sensory effects using the received sensory device control metadata.

Here, the device capability information included in the sensory device capability metadata may include device capability common information that includes information about locations and directions of sensory devices. The device capability information may include device capability detail information including information about detailed capabilities of sensory devices.

<Method and Apparatus for Providing User's Sensory Effect Preference Information>

Hereafter, a method and apparatus for providing user's sensory effect preference information in accordance with an embodiment of the present invention will be described.

The method for providing user's sensory effect preference information in accordance with the embodiment of the present embodiment includes receiving preference information about predetermined sensory effects from a user, generating user's sensory effect preference metadata including the received preference information. The user's sensory effect preference metadata includes personal preference information that describes preference information. The method for providing user's sensory effect preference metadata in accordance with the embodiment of the present embodiment further includes transmitting the user's sensory effect preference metadata to the RoSE engine.

The method for providing user's sensory effect preference metadata in accordance with the embodiment of the present embodiment may further include receiving sensory device command metadata from a RoSE engine and realizing sensory effects using sensory device command metadata. Here, the RoSE engine refers to the received user's sensory effect preference metadata to generate the sensory device command metadata.

In the method for providing user's sensory effect preference metadata in accordance with the embodiment of the present embodiment, the preference information may include personal information for identifying a plurality of users and preference description information that describes sensory effect preference information of each user. The preference description information may include effect preference information including detailed parameters for at least one of sensory effects.

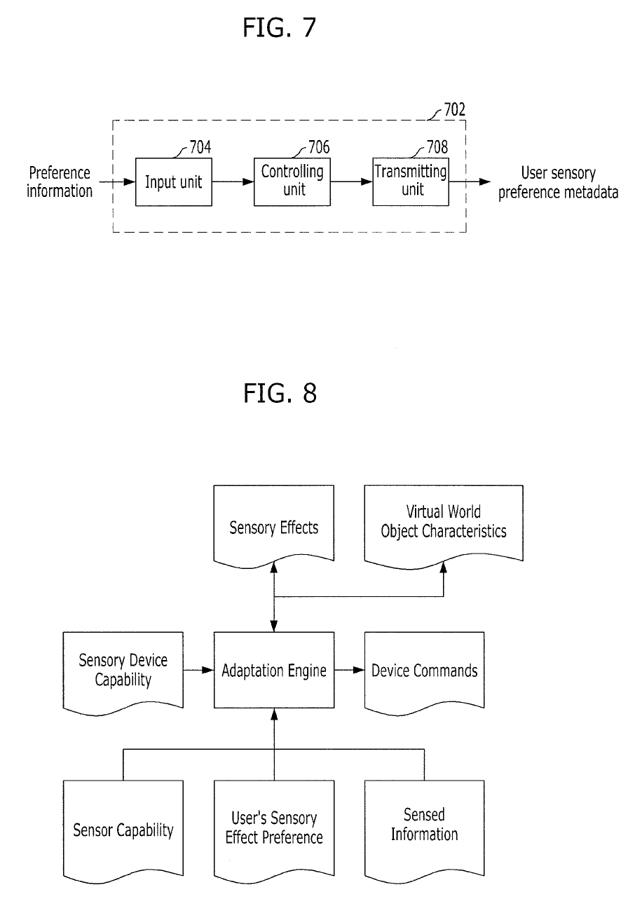

FIG. 7 is a block diagram illustrating an apparatus for providing user's sensory effect preference information in accordance with an embodiment of the present invention.

The apparatus 702 for providing user's sensory effect preference information in accordance with the embodiment of the present embodiment may be a device having the same function as a sensory device or a sensory device itself. Also, the apparatus 702 may be a stand-alone device independent from the sensory device.

As shown in FIG. 7, the apparatus 702 for providing user's sensory effect preference information in accordance with the embodiment of the present embodiment includes an input unit 704 for receiving preference information about predetermined sensory effects from a user and a controlling unit 706 for generating user's sensory effect preference metadata including the received preference information. The user's sensory effect preference metadata includes personal preference information that describes the preference information. The apparatus 702 for providing user's sensory effect preference information in accordance with the embodiment of the present embodiment may further include a transmitting unit 708 for transmitting the generated user's sensory effect preference metadata to the RoSE engine.

The input unit 704 may receive sensory device command metadata from the RoSE engine. The RoSE engine refers to the user's sensory effect preference metadata to generate the sensory device command metadata. The controlling unit 706 may realize sensory effects using the received sensory device command metadata.

The personal preference information included in the user's sensory effect preference metadata includes personal information for identifying each of users and preference description information that describes sensory effect preference of each user. The preference description information may further include effect preference information including detailed parameters about at least one of sensory effects.

<Extension of Entire System for Sensory Effect Representation—Adaptation Engine>

The system for sensory effect presentation as described above can be explained as a system which provides object characteristics of virtual world to real world. For example, the system for sensory effect presentation helps an user or real world feel that sensory effects in media or virtual world are realistic.

When providing this sensory effect service to an user, the system can acquire environment information around the user consuming the media, such as light around the user, distance between the user and media player, or user's motion. The environment information then can be used to provide sensory effect service. For example, sensory effect (temperature) can be controlled using temperature information around the user, or the user can receive warning message when the user is too close to media player. Thus, the system provides object characteristics of real world to virtual world.

The system providing interoperability in controlling devices in real world as well as in virtual world is defined as “adaptation engine”. Adaptation engine can be named as RV/VR (Real to Virtual/Virtual to Real) engine. RASE engine as described above can be included as a part of adaptation engine.

A “Sensor” can be used in adaptation engine. The sensor is a consumer device by which user input or environmental information can be gathered. For example, sensor includes temperature sensor acquiring temperature information around an user, distance sensor acquiring distance information between the user and media player, and motion sensor detecting user's motion. Sensor Capability metadata (SC) can be provided to adaptation engine to provide information of sensor capability. Also, all information which are acquired by sensor can be generated as Sensed Information metadata (SI) to control sensory devices.

FIG. 8 is a diagram illustrating relationship between adaptation engine and metadata.

<User's Sensory Effect Preference Metadata>

Hereafter, the user's sensory effect preference metadata (USED) will be described in detail.

The user's sensory effect preference metadata in accordance with the present invention includes light preference type information, flash preference type information, heating preference type information, cooling preference type information, wind preference type information, vibration preference type information, scent preference type information, fog preference type information, sprayer preference type information, and rigid body motion preference type information.

1. Light Preference Type Information

An exemplary syntax of light preference type information is as below.

```
        <!--
################################################ -->
        <!-- Light Preference type
  -->
        <!--
################################################ -->
        <complexType name=“LightPrefType”>
            <complexContent>
                <extension
base=“cidl:UserSensoryPreferenceBaseType”>
                    <sequence>
                        <element
name=“UnfavorableColor” type=“mpegvct:colorType” minOccurs=“0”
maxOccurs=“unbounded”/>
                    </sequence>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 1 summarizes the meaning of terms in above syntax.

TABLE 1

| Name | Definition |
|---|---|
| LightPrefType | Tool for describing a user preference on light |
| | effect. |
| maxIntensity | Describes the maximum desirable intensity of |
| | the light effect in terms of illumination with |
| | respect to [10⁻⁵ lux, 130 klux]. |
| unit | Specifies the unit of the maxIntensity value as |
| | a reference to a classification scheme term |
| | provided by UnitTypeCS defined in A.2.1 of |
| | ISO/IEC 23005-6, if a unit other than the |
| | default unit specified in the semantics of the |
| | maxIntensity is used. |
| UnfavorableColor | Describes the list of user's detestable colors |
| | as a reference to a classification scheme term |
| | or as RGB value. A CS that may be used for this |
| | purpose is the ColorCS defined in A.2.2 of |
| | ISO/IEC 23005-6. |
| | EXAMPLE urn:mpeg:mpeg-v:01-SI-ColorCS- |
| | NS:alice_blue would describe the color Alice |
| | blue. |

An example of a light capability description using above syntax is as below.

```
        <ControlInfo>
        <UserSensoryPreferenceList>
        <USPreference  xsi:type=“LightPrefType”
activate=“true”
        unit=“urn:mpeg:mpeg-v:01-CI-UnitTypeCS-NS:lux”
maxIntensity=“300”>
        <UnfavorableColor xsi:type=“colorType”>
        urn:mpeg:mpeg-v:01-SI-ColorCS-NS:alice_blue
        </UnfavorableColor>
        </USPreference>
        </UserSensoryPreferenceList>
        </ControlInfo>
```

In above example, the light effect is desired with the maximum intensity of 300 lux. A color, which is refused by user, is “alice_blue” from the classification scheme described in ISO/IEC 23005-3.

2. Flash Preference Type Information

An exemplary syntax of flash preference type information is as below.

```
        <!--
################################################ -->
    <!-- Flash Preference type  -->
        <!--
################################################ -->
        <complexType name=“FlashPrefType”>
            <complexContent>
                <extension base=“sepv:LightPrefType”>
                    <attribute  name=“maxFrequency”
type=“positiveInteger” use=“optional”/>
                    <attribute  name=“freqUnit”
type=“mpegvct:unitType” use=“optional”/>
                </extension>
            </complexContent>
        </complexType>
```

Table 2 summarizes the meaning of terms in above syntax.

TABLE 2

| Name | Definition |
|---|---|
| FlashPrefType | Tool for describing a user preference on flash |
| | effect. It is extended from the light type. |
| maxFrequency | Describes the maximum allowed number of |
| | flickering in times per second. |
| | EXAMPLE The value 10 means it will flicker |
| | 10 times for each second. |
| freqUnit | Specifies the unit of the maxFrequency value as |
| | a reference to a classification scheme term |
| | provided by UnitTypeCS defined in A.2.1 of |
| | ISO/IEC 23005-6, if a unit other than the |
| | default unit specified in the semantics of the |
| | maxFrequency is used. |

An example of a flash capability description using above syntax is as below.

```
        <ControlInfo>
        <UserSensoryPreferenceList>
        <USPreference  xsi:type=“FlashPrefType”
activate=“true” maxFrequency=“50”
        freqUnit=“urn:mpeg:mpeg-v:01-CI-UnitTypeCS-
NS:Hertz”/>
        </UserSensoryPreferenceList>
        </ControlInfo>
```

In above example, the flash is desired with the maximum frequency of 50 times per second.

3. Heating Preference Type Information

An exemplary syntax of heating preference type information is as below.

```
        <!--
################################################ -->
    <!-- Heating Preference type  -->
        <!--
################################################ -->
        <complexType name=“HeatingPrefType”>
            <complexContent>
                <extension
base=“cidl:UserSensoryPreferenceBaseType”>
                    <attribute  name=“minIntensity”
type=“integer” use=“optional”/>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 3 summarizes the meaning of terms in above syntax.

TABLE 3

| Name | Definition |
|---|---|
| HeatingPrefType | Tool for describing a user preference on heating |
| | effect. |
| maxIntensity | Describes the highest desirable temperature of |
| | the heating effect with respect to the Celsius |
| | scale (or Fahrenheit). |
| minIntensity | Describes the lowest desirable temperature of |
| | the heating effect with respect to the Celsius |
| | scale (or Fahrenheit). |
| unit | Specifies the unit of the maxIntensity and |
| | minIntensity value as a reference to a |
| | classification scheme term provided by |
| | UnitTypeCS defined in A.2.1 of ISO/IEC 23005-6. |

An example of a heating capability description using above syntax is as below.

```
        <ControlInfo>
        <cidl:UserSensoryPreferenceList>
            <cidl:USPreference
xsi:type=“sepv:HeatingPrefType” id=“heater001”
maxIntensity=“50” minIntensity=“20” adaptationMode=“scalable”
activate=“true”/>
        </cidl:UserSensoryPreferenceList>
        </ControlInfo>
```

In above example, the heating is desired with the maximum intensity of up to 50 degrees Celsius, and minimum intensity of 20 degrees Celsius. When the given command on the heating effect is not within the range of preference or capability, it should be properly scaled.

4. Cooling Preference Type Information

An exemplary syntax of cooling preference type information is as below.

```
        <!--
################################################ -->
    <!-- Cooling Preference type  -->
        <!--
################################################ -->
        <complexType name=“CoolingPrefType”>
            <complexContent>
                <extension
base=“cidl:UserSensoryPreferenceBaseType”>
                    <attribute  name=“minIntensity”
type=“integer” use=“optional”/>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 4 summarizes the meaning of terms in above syntax.

TABLE 4

| Name | Definition |
|---|---|
| CoolingPrefType | Tool for describing a user preference on cooling |
| | effect. |
| maxIntensity | Describes the lowest desirable temperature of |
| | the cooling effect with respect to the Celsius |
| | scale (or Fahrenheit). |
| minIntensity | Describes the highest desirable temperature of |
| | the cooling effect with respect to the Celsius |
| | scale (or Fahrenheit). |
| unit | Specifies the unit of the maxIntensity and |
| | minIntensity value as a reference to a |
| | classification scheme term provided by |
| | UnitTypeCS defined in A.2.1 of ISO/IEC 23005-6. |

An example of a cooling capability description using above syntax is as below.

```
        <ControlInfo>
        <cidl:UserSensoryPreferenceList>
            <cidl:USPreference
xsi:type=“sepv:CoolingPrefType” id=“cooling001”
maxIntensity=“10” minIntensity=“30” adaptationMode=“scalable”
activate=“true”/>
        </cidl:UserSensoryPreferenceList>
        </ControlInfo>
```

In above Example, the identifier for this preference description is “cooling001”. The cooling is desired with the maximum intensity of up to 10 degrees Celsius, and minimum intensity of 30 degrees Celsius. When the given command on the cooling effect is not within the range of preference or capability, it should be properly scaled.

5. Wind Preference Type Information

An exemplary syntax of wind preference type information is as below.

```
        <!--
################################################ -->
        <!-- Wind Preference type  -->
        <!--
################################################ -->
        <complexType name=“WindPrefType”>
            <complexContent>
                <extension
base=“cidl:UserSensoryPreferenceBaseType”>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 5 summarizes the meaning of terms in above syntax.

TABLE 5

| Name | Definition |
|---|---|
| WindPrefType | Tool for describing a user preference on a wind |
| | effect. |
| maxIntensity | Describes the maximum desirable intensity of |
| | the wind effect in terms of strength with |
| | respect to the Beaufort scale. |
| unit | Specifies the unit of the maxIntensity value as |
| | a reference to a classification scheme term |
| | provided by UnitTypeCS defined in A.2.1 of |
| | ISO/IEC 23005-6, if a unit other than the |
| | default unit specified in the semantics of the |
| | maxIntensity is used. |

An example of a wind capability description using above syntax is as below.

```
        <ControlInfo>
        <cidl:UserSensoryPreferenceList>
            <cidl:USPreference
xsi:type=“sepv:WindPrefType” id=“wind01” maxIntensity=“4”
activate=“true” adaptationMode=“strict”/>
        </cidl:UserSensoryPreferenceList>
        </ControlInfo>
```

In above example, the identifier for this preference description is “wind01”. The wind is desired with the maximum intensity of up to 4 Beaufort. When the given command on the wind effect is not within the range of preference or capability, it should be clipped.

6. Vibration Preference Type Information

An exemplary syntax of vibration preference type information is as below.

```
        <!--
################################################ -->
        <!-- Vibration Preference type  -
->
        <!--
################################################ -->
        <complexType name=“VibrationPrefType”>
            <complexContent>
                <extension
base=“cidl:UserSensoryPreferenceBaseType”>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 6 summarizes the meaning of terms in above syntax.

TABLE 6

| Name | Definition |
|---|---|
| VibrationPrefType | Tool for describing a user preference on |
| | vibration effect. |
| maxIntensity | Describes the maximum desirable intensity of the |
| | vibration effect in terms of strength with |
| | respect to the Richter magnitude scale. |
| unit | Specifies the unit of the maxIntensity value as |
| | a reference to a classification scheme term |
| | provided by UnitTypeCS defined in A.2.1 of |
| | ISO/IEC 23005-6, if a unit other than the |
| | default unit specified in the semantics of the |
| | maxIntensity is used. |

An example of a vibration capability description using above syntax is as below.

```
        <ControlInfo>
        <cidl:UserSensoryPreferenceList>
            <cidl:USPreference
xsi:type=“sepv:VibrationPrefType” id=“vibe02” maxIntensity=“3”
activate=“true” adaptationMode=“scalable”/>
        </cidl:UserSensoryPreferenceList>
        </ControlInfo>
```

In above example, the identifier for this preference description is “vibe02”. The vibration is desired with the maximum intensity of up to 3 Richter. When the given command on the vibration effect is not within the range of preference or capability, it should be properly scaled with the maximum of 3 Richter, if the maximum intensity defined in the device capability is greater than 3.

7. Scent Preference Type Information

An exemplary syntax of scent preference type information is as below.

```
        <!--
################################################ -->
        <!-- Scent Preference type  -->
        <!--
################################################-->
        <complexType name=“ScentPrefType”>
            <complexContent>
                <extension
base=“cidl:UserSensoryPreferenceBaseType”>
                    <sequence>
                        <element
name=“UnfavorableScent” type=“mpeg7:termReferenceType”
minOccurs=“0” maxOccurs=“unbounded”/>
                    </sequence>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 7 summarizes the meaning of terms in above syntax.

TABLE 7

| Name | Definition |
|---|---|
| ScentPrefType | Tool for describing a user preference on scent |
| | effect. |
| UnfavorableScent | Describes the list of user's detestable scent. ACS |
| | that may be used for this purpose is the |
| | ScentCS defined in A.2.4 of ISO/IEC 23005-6. |
| maxIntensity | Describes the maximum desirable intensity of the |
| | scent effect in terms of milliliter/hour. |
| unit | Specifies the unit of the maxIntensity value as |
| | a reference to a classification scheme term |
| | provided by UnitTypeCS defined in A.2.1 of |
| | ISO/IEC 23005-6, if a unit other than the |
| | default unit specified in the semantics of the |
| | maxIntensity is used. |

An example of a scent capability description using above syntax is as below.

```
        <ControlInfo>
        <cidl:UserSensoryPreferenceList>
            <cidl:USPreference
xsi:type=“sepv:ScentPrefType” id=“scent001” maxIntensity=“4”
adaptationMode=“scalable”>
                    <sepv:UnfavorableScent>
                    urn:mpeg:mpeg-v:01-SI-ScentCS-
NS:rose
                    </sepv:UnfavorableScent>
            </cidl:USPreference>
        </cidl:UserSensoryPreferenceList>
        </ControlInfo>
```

In above example, the identifier for this preference description is “scent001”. The scent effect is desired with the maximum intensity of up to 4 milliliter/hour. When the given command on the scent effect is not within the range of preference or capability, it should be properly scaled with the maximum of 4 milliliter/hour, if the maximum intensity defined in the device capability is greater than 4. Also, it specifies that the scent of rose as defined in ScentCS of ISO/IEC 23005-3 is not desired.

8. Fog Preference Type Information

An exemplary syntax of fog preference type information is as below.

```
        <!--
################################################-->
        <!-- Fog Preference type  -->
        <!--
################################################-->
        <complexType name=“FogPrefType”>
            <complexContent>
                <extension
base=“cidl:UserSensoryPreferenceBaseType”>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 8 summarizes the meaning of terms in above syntax.

TABLE 8

| Name | Definition |
|---|---|
| FogPrefType | Tool for describing a preference on fog effect. |
| maxIntensity | Describes the maximum desirable intensity of the fog |
| | effect in terms of milliliter/hour. |
| unit | Specifies the unit of the maxIntensity value as a reference |
| | to a classification scheme term provided by UnitTypeCS |
| | defined in A.2.1 of ISO/IEC 23005-6, if a unit other than |
| | the default unit specified in the semantics of the |
| | maxIntensity is used. |

An example of a fog capability description using above syntax is as below.

```
        <ControlInfo>
        <cidl:UserSensoryPreferenceList>
            <cidl:USPreference
xsi:type=“sepv:FogPrefType” id=“fogfog” maxIntensity=“5”
adaptationMode=“scalable”/>
        </cidl:UserSensoryPreferenceList>
        </ControlInfo>
```

In above example, the identifier for this preference description is “fogfog”. The fog effect is desired with the maximum intensity of up to 5 milliliter/hour. When the given command on the fog effect is not within the range of preference or capability, it should be properly scaled with the maximum of 5 milliliter/hour, if the maximum intensity defined in the device capability is greater than 5.

9. Spraying Preference Type Information

An exemplary syntax of spraying preference type information is as below.

```
        <!--
################################################ -->
    <!-- Spraying Preference type  -->
        <!--
################################################ -->
        <complexType name=“SprayingPrefType”>
            <complexContent>
                <extension
base=“cidl:UserSensoryPreferenceBaseType”>
                    <attribute  name=“sprayingType”
type=“mpeg7:termReferenceType”/>
                    <attribute  name=“maxIntensity”
type=“integer” use=“optional”/>
                    <attribute  name=“unit”
type=“mpegvct:unitType” use=“optional”/>
                </extension>
            </complexContent>
        </complexType>
```

Table 9 summarizes the meaning of terms in above syntax.

TABLE 9

| Name | Definition |
|---|---|
| SprayingPrefType | Tool for describing a user preference on |
| | spraying effect. |
| sprayingType | Describes the type of the sprayed material as |
| | a reference to a classification scheme term. |
| | A CS that may be used for this purpose is the |
| | SprayingTypeCS defined in Annex A.2.7 of |
| | ISO/IEC 23005-6. |
| maxIntensity | Describes the maximum desirable intensity |
| | of the spraying effect in terms of |
| | milliliter/hour. |
| unit | Specifies the unit of the maxIntensity value |
| | as a reference to a classification scheme term |
| | provided by UnitTypeCS defined in A.2.1 of |
| | ISO/IEC 23005-6, if a unit other than the |
| | default unit specified in the semantics of the |
| | maxIntensity is used. |

An example of a spraying capability description using above syntax is as below.

```
        <ControlInfo>
        <cidl:UserSensoryPreferenceList>
            <cidl:USPreference
xsi:type=“sepv:SprayingPrefType” id=“letspray”
maxIntensity=“4” sprayingType=“urn:mpeg:mpeg-v:01-SI-
SprayingTypeCS-NS:water”
          </cidl:UserSensoryPreferenceList>
        </ControlInfo>
```

In above example, the identifier for this preference description is “letspray”. The spraying effect is desired with the maximum intensity of up to 4 milliliter/hour. When the given command on the spraying effect is not within the range of preference or capability, it should be properly scaled with the maximum of 4 milliliter/hour, if the maximum intensity defined in the device capability is greater than 4. The desired material to be sprayed is purified water, as defined in the SprayingTypeCS defined in Annex A.2.9 of ISO/IEC 23005-3.

10. Rigid Body Motion Preference Type Information

An exemplary syntax of rigid body motion preference type information is as below.

```
        <!--
################################################ -->
    <!-- RigidBodyMotion Preference type  -->
        <!--
################################################ -->
        <complexType name=“RigidBodyMotionPrefType”>
            <complexContent>
                <extension
base=“cidl:UserSensoryPreferenceBaseType”>
                    <sequence  minOccurs=“1”
maxOccurs=“7”>
                        <element
name=“MotionPreference” type=“sepv:MotionPreferenceBaseType”/>
                    </sequence>
                </extension>
            </complexContent>
        </complexType>
        <!--
################################################ -->
        <!-- Motion Preference base type  -->
        <!--
################################################ -->
        <complexType  name=“MotionPreferenceBaseType”
abstract=“true”>
            <attribute  name=“unfavor” type=“boolean”
use=“optional” default=“0”/>
        </complexType>
        <!--
################################################ -->
        <!-- Move Toward Preference type
      -->
        <!--
################################################ -->
        <complexType name=“MoveTowardPreferenceType”>
            <complexContent>
                <extension
base=“sepv:MotionPreferenceBaseType”>
                    <attribute  name=“MaxMoveDistance”
type=“unsignedInt” use=“optional”/>
                    <attribute  name=“MaxMoveSpeed”
type=“float” use=“optional”/>
                    <attribute  name=“MaxMoveAccel”
type=“float” use=“optional”/>
                    <attribute  name=“distanceUnit”
type=“mpegvct:unitType” use=“optional”/>
                    <attribute  name=“speedUnit”
type=“mpegvct:unitType” use=“optional”/>
                    <attribute  name=“accelUnit”
type=“mpegvct:unitType” use=“optional”/>
                </extension>
            </complexContent>
        </complexType>
        <!--
################################################ -->
        <!-- Incline Preference type
-->
        <!--
################################################ -->
        <complexType name=“InclinePreferenceType”>
            <complexContent>
                <extension
base=“sepv:MotionPreferenceBaseType”>
                    <attribute name=“MaxRotationAngle”
type=“float” use=“optional”/>
                    <attribute name=“MaxRotationSpeed”
type=“float” use=“optional”/>
                    <attribute name=“MaxRotationAccel”
type=“float” use=“optional”/>
                    <attribute  name=“angleUnit”
type=“mpegvct:unitType” use=“optional”/>
                    <attribute  name=“speedUnit”
type=“mpegvct:unitType” use=“optional”/>
                    <attribute  name=“accelUnit”
type=“mpegvct:unitType” use=“optional”/>
                </extension>
            </complexContent>
        </complexType>
        <!--
################################################ -->
        <!-- Wave Preference type
-->
        <!--
################################################ -->
        <complexType name=“WavePreferenceType”>
            <complexContent>
                <extension
base=“sepv:MotionPreferenceBaseType”>
                    <attribute  name=“MaxWaveDistance”
type=“float” use=“optional”/>
                    <attribute  name=“MaxWaveSpeed”
type=“float” use=“optional”/>
                    <attribute  name=“distanceUnit”
type=“mpegvct:unitType” use=“optional”/>
                    <attribute  name=“speedUnit”
type=“mpegvct:unitType” use=“optional”/>
                </extension>
            </complexContent>
        </complexType>
        <!--
################################################ -->
        <!-- Collide Preference type
-->
        <!--
################################################ -->
        <complexType name=“CollidePreferenceType”>
            <complexContent>
                <extension
base=“sepv:MotionPreferenceBaseType”>
                    <attribute  name=“MaxCollideSpeed”
type=“float” use=“optional”/>
                    <attribute  name=“speedUnit”
type=“mpegvct:unitType” use=“optional”/>
                </extension>
            </complexContent>
        </complexType>
        <!--
################################################ -->
        <!-- Turn Preference type
-->
        <!--
################################################ -->
        <complexType name=“TurnPreferenceType”>
            <complexContent>
                <extension
base=“sepv:MotionPreferenceBaseType”>
                    <attribute  name=“MaxTurnSpeed”
type=“float” use=“optional”/>
                    <attribute  name=“speedUnit”
type=“mpegvct:unitType” use=“optional”/>
                </extension>
            </complexContent>
        </complexType>
        <!--
################################################ -->
        <!-- Shake Preference type
-->
        <!--
################################################ -->
        <complexType name=“ShakePreferenceType”>
            <ComplexContent>
                <extension
base=“sepv:MotionPreferenceBaseType”>
                    <attribute name=“MaxShakeDistance”
type=“float” use=“optional”/>
                    <attribute  name=“MaxShakeSpeed”
type=“float” use=“optional”/>
                    <attribute  name=“distanceUnit”
type=“mpegvct:unitType” use=“optional”/>
                    <attribute  name=“speedUnit”
type=“mpegvct:unitType” use=“optional”/>
                </extension>
            </complexContent>
        </complexType>
        <!--
################################################ -->
        <!-- Spin Preference type
-->
        <!--
################################################ -->
        <complexType name=“SpinPreferenceType”>
            <complexContent>
                <extension
base=“sepv:MotionPreferenceBaseType”>
                    <attribute  name=“MaxSpinSpeed”
type=“float” use=“optional”/>
                    <attribute  name=“speedUnit”
type=“mpegvct:unitType” use=“optional”/>
                </extension>
            </complexContent>
        </complexType>
```

From Table 10 to Table 18 summarize the meaning of terms in above syntax.

TABLE 10

| Name | Definition |
|---|---|
| RigidBodyMotionPrfType | Tool for describing a user preference on |
| | Rigid body motion effect. |
| MotionPreferece | Describes the user preference for various |
| | types of rigid body motion effect. This |
| | element shall be instantiated by typing |
| | any specific extended type of |
| | MotionPreferenceBaseType. |

TABLE 11

| Name | Definition |
|---|---|
| MotionPrferenceBaseType | Provides base type for the type |
| | hierarchy of individual motion related |
| | preference types. |
| Unfavor | Describes the user's distasteful motion |
| | effect. |
| | EXAMPLE The value “true” means the |
| | user has a dislike for the specific |
| | motion sensory effect. |

TABLE 12

| Name | Definition |
|---|---|
| MoveTowardPreference | Tool for describing a user preference on |
| Type | move toward effect. |
| MaxMoveDistance | Describes the maximum desirable distance |
| | of the move effect with respect to the |
| | centimeter. |
| | EXAMPLE The value ‘10’ means the user does |
| | not want the chair move more than 10 cm. |
| MaxMoveSpeed | Describes the maximum desirable speed of |
| | move effect with respect to the centimeter |
| | per second. |
| | EXAMPLE The value ‘10’ means the user does |
| | not want the chair speed exceed more than |
| | 10 cm/s. |
| MaxMoveAccel | Describes the maximum desirable |
| | acceleration of move effect with respect |
| | to the centimeter per square second. |
| distanceUnit | Specifies the unit of the distance, as a |
| | reference to a classification scheme term |
| | provided by UnitTypeCS defined in A.2.1 of |
| | ISO/IEC 23005-6. |
| speedUnit | Specifies the unit of the speed, as a |
| | reference to a classification scheme term |
| | provided by UnitTypeCS defined in A.2.1 of |
| | ISO/IEC 23005-6. |
| accelUnit | Specifies the unit of the acceleration, as |
| | a reference to a classification scheme |
| | term provided by UnitTypeCS defined in |
| | A.2.1 of ISO/IEC 23005-6. |

TABLE 13

| Name | Definition |
|---|---|
| InclinePreferenceType | Tool for describing a user preference on |
| | motion chair incline effect. |
| MaxRotationAngle | Describes the maximum desirable rotation |
| | angle of incline effect. |
| MaxRotationSpeed | Describes the maximum desirable rotation |
| | speed of incline effect with respect to |
| | the degree per second. |
| | EXAMPLE The value ‘10’ means the user does |
| | not want the chair speed exceed more than |
| | 10 degree/s. |
| MaxRotationAccel | Describes the maximum desirable rotation |
| | acceleration of incline effect with |
| | respect to the degree per second. |
| angleUnit | Specifies the unit of the angle, as a |
| | reference to a classification scheme term |
| | provided by UnitTypeCS defined in A.2.1 of |
| | ISO/IEC 23005-6. |
| speedUnit | Specifies the unit of the speed, as a |
| | reference to a classification scheme term |
| | provided by UnitTypeCS defined in A.2.1 of |
| | ISO/IEC 23005-6. |
| accelUnit | Specifies the unit of the acceleration, as |
| | a reference to a classification scheme |
| | term provided by UnitTypeCS defined in |
| | A.2.1 of ISO/IEC 23005-6. |

TABLE 14

| Name | Definition |
|---|---|
| WavePreferenceType | Tool for describing a user preference on |
| | wave effect. |
| MaxWaveDistance | Describes the maximum desirable distance |
| | of wave effect with respect to the |
| | centimeter. |
| | NOTE Observe the maximum distance among |
| | the distance of yawing, rolling and |
| | pitching. |
| MaxWaveSpeed | Describes the maximum desirable speed of |
| | wave effect in terms of cycle per second. |
| | NOTE Observe the maximum speed among the |
| | speed of yawing, rolling and pitching. |
| distanceUnit | Specifies the unit of the distance, as a |
| | reference to a classification scheme term |
| | provided by UnitTypeCS defined in A.2.1 of |
| | ISO/IEC 23005-6. |
| speedUnit | Specifies the unit of the speed, as a |
| | reference to a classification scheme term |
| | provided by UnitTypeCS defined in A.2.1 of |
| | ISO/IEC 23005-6. |

TABLE 15

| Name | Definition |
|---|---|
| CollidePreferenceType | Tool for describing a user preference on |
| | motion chair collision effect. |
| MaxCollideSpeed | Describes the maximum desirable speed of |
| | collision effect with respect to the |
| | centimeter per second. |
| | EXAMPLE The value ‘10’ means the user does |
| | not want the chair speed exceed more than |
| | 10 cm/s. |
| speedUnit | Specifies the unit of the speed, as a |
| | reference to a classification scheme term |
| | provided by UnitTypeCS defined in A.2.1 of |
| | ISO/IEC 23005-6. |

TABLE 16

| Name | Definition |
|---|---|
| TurnPreferenceType | Tool for describing a user preference on |
| | turn effect. |
| MaxTurnSpeed | Describes the maximum desirable speed of |
| | turn effect with respect to the degree per |
| | second. |
| | EXAMPLE The value ‘10’ means the user does |
| | not want the chair speed exceed more than |
| | 10 degree/s. |
| speedUnit | Specifies the unit of the speed, as a |
| | reference to a classification scheme term |
| | provided by UnitTypeCS defined in A.2.1 of |
| | ISO/IEC 23005-6. |

TABLE 17

| Name | Definition |
|---|---|
| ShakePreferenceType | Tool for describing a user preference on |
| | motion chair shake effect. |
| MaxShakeDistance | Describes the maximum desirable distance |
| | of the shake effect with respect to the |
| | centimeter. |
| | EXAMPLE The value ‘10’ means the user does |
| | not want the chair shake more than 10 cm. |
| MaxShakeSpeed | Describes the maximum desirable speed of |
| | shake effect in terms of cycle per second. |
| | EXAMPLE The value ‘1’ means the motion |
| | chair shake speed can't exceed 1 cycle/sec. |
| distanceUnit | Specifies the unit of the distance, as a |
| | reference to a classification scheme term |
| | provided by UnitTypeCS defined in A.2.1 of |
| | ISO/IEC 23005-6. |
| speedUnit | Specifies the unit of the speed, as a |
| | reference to a classification scheme term |
| | provided by UnitTypeCS defined in A.2.1 of |
| | ISO/IEC 23005-6. |

TABLE 18

| Name | Definition |
|---|---|
| SpinPreferenceType | Tool for describing a user preference on |
| | motion chair spin effect. |
| MaxSpinSpeed | Describes the maximum desirable speed of |
| | spin effect in terms of cycle per second. |
| | EXAMPLE The value ‘1’ means the motion |
| | chair spin speed can't exceed 1 cycle/sec. |
| speedUnit | Specifies the unit of the speed, as a |
| | reference to a classification scheme term |
| | provided by UnitTypeCS defined in A.2.1 of |
| | ISO/IEC 23005-6. |

An example of a rigid body motion capability description using above syntax is as below.

| <sepv:MoveTowardPreference | |
|---|---|
| xsi:type=“sepv:MoveTowardPreferenceType” unfavor=“true”/> | |
| <sepv:InclinePreference | |
| xsi:type=“sepv:InclinePreferenceType” | unfavor=“false” |
| MaxRotationSpeed=“10”/> | |
| <sepv:WavePreference | |
| xsi:type=“sepv:WavePreferenceType” | unfavor=“false” |
| MaxWaveDistance=“20” MaxWaveSpeed=“2”/> | |
| <sepv:CollidePreference | |
| xsi:type=“sepv:CollidePreferenceType” unfavor=“true”/> | |
| <sepv:ShakePreference | |
| xsi:type=“sepv:ShakePreferenceType” | unfavor=“false” |

```
MaxShakeDistance=“20” MaxShakeSpeed=“5”/>
        <sepv:SpinPreference xsi:type=“sepv:SpinPreference”
unfavor=“true”/>
        <sepv:TurnPreference
xsi:type=“cidTurnPreferenceType” MaxTurnSpeed=“10”/>
```

In above example, MoveToward effect, Collide effect and Spin effect are not permitted. Incline effect is permitted and maximum rotation speed is limited to 10 degree/sec. Wave effect is permitted and maximum wave amplitude and maximum wave speed is limited to 20 cm and 2 cm/sec, respectively. Shake effect is permitted and maximum amplitude and maximum speed is limited to 20 cm and 5 cm/sec. Turn effect is permitted and maximum speed is limited to 10 cm/sec.

While the present invention has been described with respect to the specific embodiments, it will be apparent to those skilled in the art that various changes and modifications may be made without departing from the spirit and scope of the invention as defined in the following claims.

What is claimed is:

1. A method for providing user's sensory effect preference information, comprising:
receiving preference information for predetermined sensory effect from a user; and
generating user's sensory effects preference metadata including the preference information,
wherein the user's sensory effects preference metadata comprises light preference type information, flash preference type information, heating preference type information, cooling preference type information, wind preference type information, vibration preference type information, scent preference type information, fog preference type information, sprayer preference type information, and rigid body motion preference type information.

2. The method of claim 1, further comprising transmitting the user's sensory effects preference metadata to sensory effect representation device.

3. The method of claim 2, further comprising:
receiving sensory device command metadata from the sensory effect representation device; and
realizing sensory effect using the user's sensory effects preference metadata and the sensory device command metadata.

4. The method of claim 1, wherein the light preference type information comprises max intensity information, unit information, and unfavorable color information.

5. The method of claim 1, wherein the flash preference type information comprises max frequency information and unit information.

6. The method of claim 1, wherein the heating preference type information comprises max intensity information, min intensity information, and unit information.

7. The method of claim 1, wherein the cooling preference type information comprises max intensity information, min intensity information, and unit information.

8. The method of claim 1, wherein the wind preference type information comprises max intensity information and unit information.

9. The method of claim 1, wherein the vibration preference type information comprises max intensity information and unit information.

10. The method of claim 1, wherein the scent preference type information comprises unfavorable scent information, max intensity information, and unit information.

11. The method of claim 1, wherein the fog preference type information comprises max intensity information and unit information.

12. The method of claim 1, wherein the spraying preference type information comprises spraying type information, max intensity information, and unit information.

13. The method of claim 1, wherein the rigid body motion preference type information comprises unfavorable motion information, move toward motion preference type information, incline motion preference type information, wave motion preference type information, collide motion preference type information, turn motion preference type information, shake motion preference type information, and spin motion preference type information.

14. An apparatus for providing user's sensory effect preference information, comprising:
an input unit configured to receive preference information for predetermined sensory effect from a user; and
a control unit configured to generate user's sensory effects preference metadata including the preference information,
wherein the user's sensory effects preference metadata comprises light preference type information, flash preference type information, heating preference type information, cooling preference type information, wind preference type information, vibration preference type information, scent preference type information, fog preference type information, sprayer preference type information, and rigid body motion preference type information.

15. A method for representing sensory effect, comprising:
receiving sensory effect metadata for a sensory effect which is applied to media;
analyzing the sensory effect metadata and acquiring sensory effect information;
receiving user's sensory effects preference metadata including user's preference information for predetermined sensory effect; and
generating sensory device command metadata for controlling sensory device corresponding to the sensory effect information referring to the preference information included in the user's sensory effects preference metadata,
wherein the user's sensory effects preference metadata comprises light preference type information, flash preference type information, heating preference type information, cooling preference type information, wind preference type information, vibration preference type information, scent preference type information, fog preference type information, sprayer preference type information, and rigid body motion preference type information.

16. An apparatus for representing sensory effect, comprising:
an input unit configured to receive sensory effect metadata for a sensory effect which is applied to media and user's sensory effects preference metadata including user's preference information for predetermined sensory effect;
a control unit configured to analyze the sensory effect metadata, acquire sensory effect information, and generate sensory device command metadata for controlling sensory device corresponding to the sensory effect information referring to the preference information included in the user's sensory effects preference metadata,
wherein the user's sensory effects preference metadata comprises light preference type information, flash preference type information, heating preference type information, cooling preference type information, wind preference type information, vibration preference type information, scent preference type information, fog preference type information, sprayer preference type information, and rigid body motion preference type information.
